(19) United States
(12) Patent Application Publication
(10) Pub. No.: US 2025/0113885 A1
(43) Pub. Date: Apr. 10, 2025

(54) WEARABLE DEVICE, POWER TOOL SYSTEM COMPRISING A HAND-HELD POWER TOOL AND SUCH A WEARABLE DEVICE, AND ELECTRONIC APPLIANCE SYSTEM COMPRISING AN ELECTRONIC APPLIANCE AND SUCH A WEARABLE DEVICE

(71) Applicant: Guido VALENTINI, Milano (IT)

(72) Inventor: Guido VALENTINI, Milano (IT)

(21) Appl. No.: 18/887,263

(22) Filed: Sep. 17, 2024

(30) Foreign Application Priority Data
Oct. 10, 2023 (EP) 23 202 660.9

(51) Int. Cl. A41D 19/015; A41D 19/00

(52) U.S. Cl. CPC A41D 19/01582; A41D 19/0037

(57) ABSTRACT

A wearable device (200), including a glove (202) or a bracelet (204) or a ring (206), adapted to be worn by a user of a hand-held power tool (100) on or close to a hand (10) of the user while holding the power tool (100) with the hand (10), having a support structure (212; 214; 218) adapted to be releasably attached to the user's hand (10) and at least one sensor device (208) held by the support structure (212; 214; 218), and being configured to detect an operational status of the power tool (100) held by the user when using the power tool (100) and also configured to generate and output at least one sensor signal (210) indicative of the detected operational status of the power tool (100).

The present invention refers to a wearable device, comprising a wearable device in the form of a glove or a bracelet or a ring. The wearable device is adapted to be worn by a user of a hand-held power tool on or close to a hand of the user while holding the power tool with that hand.

Further, the invention refers to a power tool system comprising a hand-held power tool and a wearable device, comprising a wearable device in the form of a glove or a bracelet or a ring. The power tool is configured to be held by a user during intended use of the power tool. The wearable device is adapted to be worn by the user on or close to a hand of the user while holding the power tool with that hand.

Finally, the invention refers to an electronic appliance system comprising an electronic appliance and a wearable device, comprising a wearable device in the form of a glove or a bracelet or a ring. The wearable device is adapted to be worn by a user of a hand-held power tool on or close to a hand of the user while holding the power tool with that hand.

In particular, wearable devices of the above-mentioned kind are known in the form of rings, bracelets or gloves. Rings may be worn on one of a user's fingers, bracelets may be worn around a user's wrist and gloves may be worn on a user's hand and may cover the entire hand or only part of it, e.g., leaving free the finger tips. Wearable devices in the form of gloves provided with pressure sensors are known for determining grasping forces of a user when grasping an object. Furthermore, wearable devices in the form of gloves provided with strain sensors are known for detecting and monitoring hand gestures of a user to provide data to quantify these motions. Further, wearable devices in the form of gloves provided with acceleration sensors are known for identifying pseudo static gestures and for allowing the glove to be used as a mouse pointing device.

Prior art reference US 2016/187 973 A1 discloses a wearable device in the form of a flexible smart glove provided with capacitive micro-sensors at finger joint locations for detecting fine hand and finger motions while permitting the wearer to make hand gestures with dexterity, i.e., the ability to use one's hands with precision, accuracy, and skill.

Prior art reference US 2021/362 322 A1 discloses a wearable device in the form of a glove and a method for controlling a robot for handling a part to be handled. The handling robot is linked to a control interface comprising the glove provided with contact sensors at two or more fingers. The robot is controlled by a combination of signals originating from the sensors.

Prior art reference EP 2 630 558 A1 discloses a wearable device in the form of an electronic control glove provided with conductive pads at the tip of the thumb on the one hand and at various positions along the longitudinal extension of the fingers on the other hand. Remote electronic appliances may be controlled with the glove by bringing the conductive pad of the thumb into contact with different contact pads of the fingers. The electronic appliances may be cell phones, audio players, garage door openers, military hardware and software, in work environments and so on. Control signals are transmitted wirelessly from the electronic control glove to the electronic appliance to be controlled.

Known wearable devices in the form of a sensor glove or the like all have in common that their principal idea is to use gestures of a hand wearing the sensor glove or the movement of fingers or of that hand for controlling operation of an external electronic appliance, similar to a magician using his magic wand to make movements in the air in order to move distant objects or have them perform some other action.

In the technical field of car body repair or vehicle detailing, generally, a user holds a hand-held power tool, in particular in the form of a polishing or sanding power tool, with at least one of his hands and moves the power tool towards and on a working surface manually by hand. The power tool may be provided with a dust outlet. Dust and small particles created during intended use of the power tool may be conveyed towards the dust outlet by an integrated dust extraction (or automatic dust aspiration) system of the power tool and may be collected in a dust collection filter element attached to the dust outlet, e.g., like the one known from EP 1 849 555 A1. Alternatively or additionally, a distal end of a suction hose of a vacuum cleaner may be attached to the dust outlet in order to convey the dust laden air into a dust collection chamber of the vacuum cleaner. So, when working in the field of car body repair with a power tool and a vacuum cleaner attached thereto, operation of the power tool and the vacuum cleaner should be coordinated.

It is known in the prior art to provide the distal end of the suction hose of a vacuum cleaner, attached to a dust outlet of a power tool, with a sensor device for determining the operational status of the power tool, in particular vibrations, during intended use of the power tool. The distal end may further be provided with a wireless communication device for transmitting control signals to the vacuum cleaner for controlling its operation depending on the operation status of the power tool.

It is an object of the present invention to suggest an alternative possibility for detecting an operational status of a power tool currently used by a user. The alternative proposal is preferably easy and safe to use and allows a correct and reliable detection of the current operational status of the power tool throughout the intended use of the power tool.

In order to solve this object, the invention suggests a wearable device comprising the features of claim 1. In particular, starting from the wearable device of the above-identified kind, it is suggested that the wearable device comprises a support structure adapted to be releasably attached to the user's hand and at least one sensor device held by the support structure and configured to detect an operational status of the power tool held by the user during intended use of the power tool and further configured to generate and output at least one sensor signal indicative of the detected operational status of the power tool.

The support structure of the wearable device is designed such that, in the case of a ring, it may be worn and firmly held on a user's finger, in the case of a bracelet, it may be worn around a user's wrist and securely held on the user's wrist, and, in the case of a glove, it may be worn on a user's hand and cover the entire hand or only part of it. The support structure may be rigid or flexible, preferably elastic. The support structure may comprise any material including metal, wood, plastic, a mesh of natural or synthetic fibres, some kind of fabric made of synthetic or natural materials, synthetic or natural leather, or the like.

The present invention takes advantage of the fact that the user usually clasps or holds the power tool tightly with his hand. Thus, an operational status of the power tool may be transmitted practically undamped to the hand or the wearable device detachably attached to the hand. Alternatively, the hand clasping or holding the power tool is located so close to the power tool that certain operational status of the power tool may be directly detected by a respective sensor device integrated into the wearable device.

Preferably, the at least one sensor device is integrated into the wearable device and not visible from outside the wearable device without disassembling or destroying the wearable device.

The operational status of the power tool which may be detected by the at least one sensor device integrated into the wearable device may comprise an on/off-status of the power tool, a rotational speed of a working element, e.g., in the form of a backing plate in a polishing or sanding power tool, an operation temperature of the power tool (which is useful for proactively determining an excessive operation temperature, which might be indicative of a defect of the tool motor, and for preventing over-heating of the motor), current vibration values of the power tool (which is useful for determining excessive vibrations, which might be indicative of using a wrong backing plate and/or a wrong polishing or sanding member, and/or of mechanical problems of the power tool), irregularities of vibrations (which is useful for determining mechanical problems of the power tool), frequencies of vibrations (which is useful for determining a maximum time of usage of the power tool by a user without exceeding an allowed vibration level over time to which the user is exposed), accumulated vibrations over a certain period of time, electric energy or power consumption of the tool motor (which is useful for proactively determining an excessive electric current consumption, which might be indicative of a defect of the tool motor), overall tool usage time (which is useful, for example, for scheduling predictive maintenance), etc.

The user of a power tool often wears working gloves anyway to protect his hands from injury and dirt during the intended use of the power tool. According to the invention, these working gloves may be easily equipped with the at least one sensor element.

According to a preferred embodiment of the invention, it is suggested that the at least one sensor device is configured to detect an operational status of a motor of the power tool. The motor may be a pneumatic motor or an electric motor, in particular a brushless electric motor. The operational status of the motor may comprise an on/off-status of the motor, a rotational speed of a motor shaft, an operation temperature of the motor, current vibration values of the motor shaft, irregularities of vibrations, frequencies of vibrations, accumulated vibrations over a certain period of time, electric energy or power consumption of the tool motor, overall usage time of the motor etc.

Alternatively or additionally, the at least one sensor device may also be configured to detect an operational status of a working element of the power tool, in particular of a backing plate of a polishing or sanding power tool. Alternatively, the working element may also be a chuck of a drill or the like. The operational status of the working element may comprise an on/off-status, i.e., rotating yes or no, of the backing plate, a rotational speed of the backing plate, current vibration values of the backing plate (with a polishing or sanding member attached thereto), irregularities of vibrations, frequencies of vibrations, accumulated vibrations over a certain period of time, overall usage time of the same working element, etc. The polishing member could be a polishing pad made of foam, wool and/or microfiber. The sanding member could be a sanding fabric or a sanding paper. A decentralised or eccentric attachment of the polishing or sanding member to a bottom surface of the backing plate may result in larger vibrations of the backing plate and of the entire power tool.

The at least one sensor device may be configured to detect vibrations caused by the power tool during its intended use. In this case, the at least one sensor device preferably comprises an acceleration sensor. Vibrations of the motor or of the working element during intended use of the power tool are transmitted to the tool housing and further to the hand of the user holding the power tool and further to the wearable device removably attached to the user's hand. The at least one sensor device may then detect these vibrations of the wearable device and can then draw conclusions about the vibrations of the power tool, the motor or the working element.

By monitoring and evaluating characteristic courses of the vibrations over time, conclusions can be drawn about the speed of the power tool, the motor or the backing plate. These conclusions can be drawn from the course of the values of the vibrations or from the course of the frequencies of the vibrations over time.

Alternatively or additionally, the at least one sensor device may be configured to detect a speed of the power tool, the motor or the backing plate. In this case, the at least one sensor device preferably comprises a radio receiver adapted for receiving a radio signal from the power tool transmitting information relating to the speed of the power tool, the motor, or the backing plate. The speed value can be measured by means of a sensor making part of the power tool, e.g., a magnetic field sensor, e.g., a Hall effect sensor, and transmitted to a motor control unit of the power tool. Anyhow, even in power tools with sensorless motor control, the motor control unit usually has an exact or estimated value of the current speed of the motor. The speed value can be transmitted to the radio receiver of the wearable device by means of one or more radio signals. Alternatively, the sensor device may comprise a magnetic field sensor, e.g., a Hall effect sensor, and the working element, e.g., the backing plate, may be provided with one or more permanent magnets which create a magnetic field which rotates together with the working element during intended use of the power tool. The changes of the magnetic field during rotation of the working element can be detected by the sensor device and from that the speed of the backing plate can be determined.

According to a preferred embodiment of the invention, the wearable device comprises an electric energy storage device and/or an electric energy generation device, preferably held by the support structure and configured to provide electric energy to the at least one sensor device for its operation and possibly to further electric or electronic components making part of the wearable device for their operation. The electric energy storage device comprises batteries (exchangeable or rechargeable), capacitors or the like. An electric energy generation device may generate electric energy during intended use of the power tool, which is held by the user with his hand. For instance, the energy generating device can create electric energy from vibrations occurring during intended use of the power tool. The energy generation device may be connected to the at least one sensor device and possibly to other electric or electronic components of the wearable device either directly or indirectly through the electric energy storage device, which could serve as an intermediate storage or buffer for the electric energy generated by the energy generating device. Preferably, the energy generating device is manufactured in semiconductor technology and comprises, for instance, a piezoelectric element configured to transform mechanical movement into electric energy.

According to another embodiment it is suggested that the wearable device comprises a further electric or electronic component in the form of a processing module, preferably held by the support structure and adapted for receiving the at least one sensor signal from the at least one sensor device and for processing the received at least one sensor signal. The processing module may comprise a microprocessor or a microcontroller adapted to execute a computer program stored on a storage device making part of the processing module or being separate from the processing module but accessible by the processing module. The computer program is programmed to make the processing module perform its processing functionality when executed on the processing module. The processing functionality may comprise one or more of the following:
receiving the at least one sensor signal indicative of the detected operational status of the power tool from the at least one sensor device of the wearable device,
extracting the operational status of the power tool from the at least one received sensor signal,
generating at least one control signal depending on the extracted operational status of the power tool,
forwarding the at least one control signal to at least one further electric or electronic component of the wearable device, e.g., to the processing module, a visual output device,
controlling operation of the at least one sensor device and possibly of at least one further electric or electronic component of the wearable device, e.g., of the processing module, of a visual output device.

The wearable device may comprise a further electric or electronic component in the form of a visual output device, preferably held by the support structure and adapted for visualizing to the user holding the power tool an indication of the operational status of the power tool or the operational status of the power tool itself. The information visualized by the visual output device may be controlled by the processing module.

The visual output device may comprise one or more light points capable of emitting light with different brightness, flashing intervals and/or colours. For instance, the light points may comprise one or more LEDs capable of emitting light of different colours or an RGB-LED. Light emitted from one or more of the light points with a certain brightness, flashing interval and/or colour is representative of a certain operational status of the power tool.

Furthermore, the visual output device may comprise a light guide or an electroluminescent (EL) wire having a longitudinal extension. Light with different brightness, flashing intervals and/or colours may be coupled into the light guide, preferably at a distal end thereof, propagated along the longitudinal extension of the ight guide, preferably by means of total internal reflection (TIR) and finally coupled out of the light guide along the longitudinal extension of the light guide in a radial direction. To this end, the light guide may be provided with respective decoupling elements along the longitudinal extension of the light guide.

An EL wire is a flexible lighting product that emits light when an alternating current (AC) voltage is applied to it. It comprises a thin copper or tin-plated wire coated with a phosphor material and encased in a transparent or translucent PVC sheath. The phosphor material can emit light when excited by an energy source, such as an electric current. An EL wire requires an AC power source, typically in the range of 50-2000 Hz. The AC power source is necessary because it alternates the polarity of the voltage, which prevents the wire from overheating and ensures even illumination along its length. The processing module may act as the AC power source in the wearable device. When the AC voltage is applied to the EL wire, it causes the phosphor coating to emit light through a process called electroluminescence. The alternating current excites the phosphor molecules, which then release energy in the form of visible light. The EL wire is encased in a transparent or translucent PVC sheath that protects the wire and allows the emitted light to pass through. The sheath also helps diffuse the light, resulting in a more uniform and glowing appearance. Different types of phosphors can be used to produce different colours of light, such as green, blue, red, or white. Additionally, an EL wire can be made to have various lighting effects, including steady glow, blinking, or chasing patterns by controlling the AC power source. To power the EL wire, an inverter is required to convert a DC power source (such as batteries) into the AC voltage needed for the EL wire to function. The inverter generates the appropriate frequency and voltage to drive the EL wire and typically includes controls for adjusting brightness and lighting modes. The inverter functionality can be performed by the processing module or by a separate component, which is possibly controlled by the processing module.

Finally, the visual output device may also comprise a graphic display or screen, such as a LED-display, an OLED-display, or the like. Such displays or screens may output the detected operational status of the power tool graphically, for instance in the form of a graph over time, a bar graph, a column graph, as a virtual analogue display with pointer instrument, as virtual digital display with numbers or the like. The graphic display or screen may be a touch-sensitive display or screen providing a user control interface adapted to be actuated by the user holding the power tool in order to achieve a user-individual control of the wearable device and/or of one or more remote external electronic appliances, such as a vacuum cleaner, as will be described in more detail below.

Preferably, the visual output device is located in the wearable device such that the user wearing the wearable device on or near his hand can grasp the information displayed while holding the power tool with his hand and using the power tool as intended. For instance, in the case of a wearable device in the form of a glove, it is suggested that the visual output device is located on the back of the hand or glove.

According to another preferred embodiment of the invention, it is suggested that the wearable device comprises a further electric or electronic component in the form of at least one user control interface, preferably held by the support structure and adapted to be actuated by the user holding the power tool in order to achieve a user-individual control of the wearable device. The user control interface comprises one or more physical or virtual buttons, knobs, rotary or slider controls, input fields for entering data or quantities, etc. Preferably, the user control interface is configured such that it can be actuated by the user even when wearing gloves.

Finally, it is suggested that the wearable device comprises a further electric or electronic component in the form of a wireless communication device, preferably held by the support structure and adapted for establishing a wireless communication link to an external electronic appliance and for transmitting across the wireless communication link a wireless signal containing information indicative of the detected operational status of the power tool. The wireless communication device may be controlled by a processing module of the wearable device. To this end, it is further suggested that the wireless communication device is connected to the processing module and adapted to receive control signals from the processing module in order to make the wireless communication device establish the wireless communication link to the external electronic appliance and transmit across the wireless communication link the wireless signal containing the information indicative of the detected operational status of the power tool.

The wireless communication device is in particular configured to establish a radio communication link to the external electronic appliance using any desired frequency range. The wireless communication device is in particular configured to transmit across the wireless communication link the wireless signal containing the information indicative of the detected operational status of the power tool according to any given data transmission protocol, be it known in the art or be it a proprietary protocol. Examples for protocols which may be used for data transmission from the wireless communication device to the external electronic appliance are: WiFi, any cellular network protocol (GSM, UMTS, LTE, 5G), Bluetooth, ZigBee, Z-Wave (operating in sub-GHz frequency range), Thread (IP-based wireless networking protocol using low-power IEEE 802.15.4 radio standard and operating on 2.4 GHz frequency), WirelessHART (based on HART (Highway Addressable Remote Transducer) protocol and operating in the 2.4 GHz frequency range), ANT/ANT+ (operating on 2.4 GHz frequency and typically offering low-power, short-range communication between sensors and display devices), EnOcean (focussing on energy harvesting and ultra-low-power devices, enabling self-powered devices to transmit data wirelessly using energy from their surroundings, such as solar, thermal, or mechanical energy), just to name a few.

Examples for electronic appliances, to which the wireless communication device my establish the wireless communication link, are:
an external display device, possibly making part of a smartphone or the like (one or more detected operational states of the power tool or any other information received from the wireless communication device of the wearable device can be displayed on the external display device),
a vacuum cleaner having a suction hose the distal end of which being attached to the dust outlet of the power tool held by the user (the vacuum cleaner may be controlled automatically depending on the information received from the wireless communication device and indicative of the operational state of the power tool; when the power tool is turned on, the vacuum cleaner may also be turned on, and when the power tool is turned off, the vacuum cleaner may also be turned off, possibly with a slight time delay),
the power tool held by the user (the power tool housing may be equipped with a visual output device, which may display to the user information received from the wireless communication device; operation of the power tool may be adapted or controlled based on the information received from the wireless communication device).

In order to establish the wireless communication link to the external electronic appliance, the appliance is provided with a respective wireless communication device. The data transmission between the wireless communication devices of the wearable device and the electronic appliance is preferably bi-directional, at least during establishing and setting up the wireless communication link. The actual data transmission may be uni-or bi-directional.

Signal transmission between various electric or electronic components of the wearable device may be effected by means of electrically conductive cables, conductive paths of flexible or rigid PCBs or the like. Alternatively, signal transmission between the components of the wearable device may also be realized through radio transmission. The power transmission from the electric energy storage device and/or the energy generation device to the one or more electric or electronic components of the wearable device is preferably realized through conductive cables, flexible or rigid PCBs or inductively.

The object of the present invention is also solved by a power tool system comprising a hand-held power tool configured to be held by a user during intended use of the power tool and a wearable device, preferably in the form of a glove or a bracelet or a ring. The wearable device is adapted to be worn by the user on or close to a hand of the user while holding the power tool with that hand. It is suggested that the wearable device has the features of the present invention described above. Preferably, the power tool comprises a polishing or sanding power tool, in particular an angular polishing or sanding power tool.

The object of the present invention is also solved by an electronic appliance system comprising an electronic appliance and a wearable device, preferably in the form of a glove or a bracelet or a ring. The wearable device is adapted to be worn by a user of a hand-held power tool on or close to a hand of the user while holding the power tool with that hand. It is suggested that the wearable device has the features of the present invention described above. Preferably, the electronic appliance comprises a vacuum cleaner separate from the power tool held by the user, the power tool held by the user or a smartphone, a tablet computer, a laptop computer or any other kind of computer system. The vacuum cleaner has a suction hose the distal end of which being attached to the dust outlet of the power tool held by the user. The vacuum cleaner may be controlled automatically depending on the information received from the wireless communication device and indicative of the operational state of the power tool. When the power tool is turned on, the vacuum cleaner may also be turned on, and when the power tool is turned off, the vacuum cleaner may also be turned off, possibly with a slight time delay. The power tool housing of the power tool held by the user may be equipped with a visual output device, which may display to the user information received from the wireless communication device during intended use of the power tool by the user. Alternatively, operation of the power tool may be adapted or controlled based on the information received from the wireless communication device. In particular, the speed of the motor or of the backing plate of the power tool, respectively, may be altered in order to adapt it to certain characteristics of the working surface to be worked, environmental properties, one or more operational parameters of the power tool, and in order to optimize the working result. A display or screen of the smartphone, tablet computer, laptop computer or any other kind of computer system may be used as visual output device adapted for visualizing to the user holding the power tool an indication of the operational status of the power tool or the operational status itself. A keypad or a touch sensitive display of the smartphone, tablet computer, laptop computer or any other kind of computer system may be used as a user control interface adapted to be actuated by the user holding the power tool in order to achieve a user-individual control of the wearable device, the power tool and/or the vacuum cleaner.

Further characteristics and advantages of the present invention will be described in more detail hereinafter making reference to the accompanying drawings. Each of the features shown in the drawings may be of particular importance for the invention individually without the other features shown in the respective drawings even if not explicitly mentioned in the description. Furthermore, any combination of features shown in the drawings may be of particular importance for the invention individually even if that combination is not explicitly shown in the drawings and/or mentioned in the description. The drawings show:

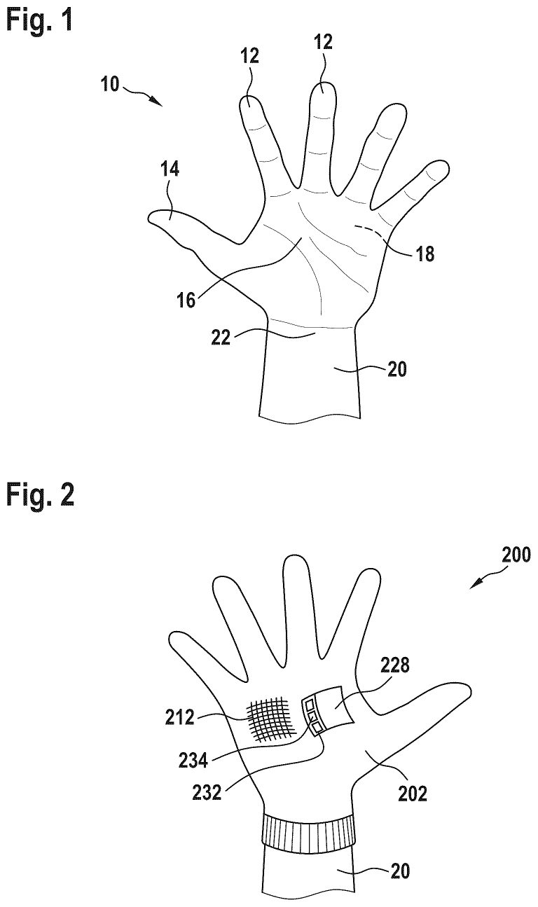

FIG. 1 a hand with which a user can hold a tool housing of a hand-held power tool;

FIG. 2 a wearable device according to the invention according to a first embodiment;

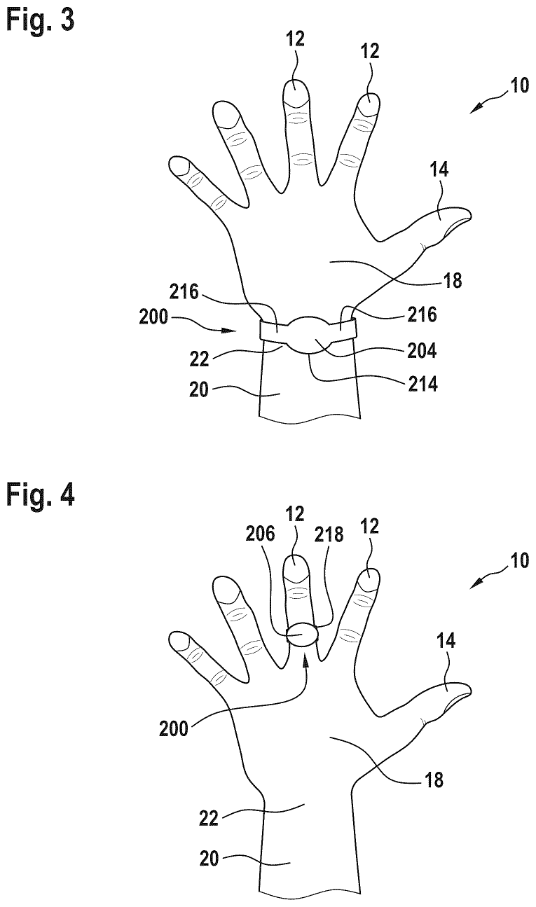

FIG. 3 a wearable device according to the invention according to a second embodiment;

FIG. 4 a wearable device according to the invention according to a third embodiment;

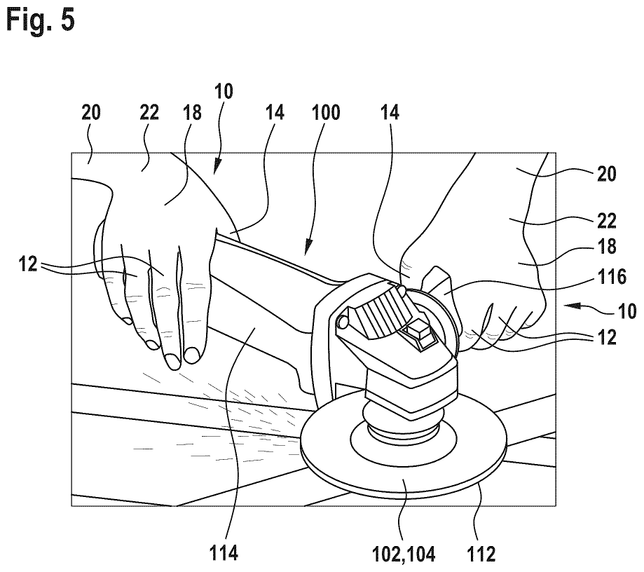

FIG. 5 a power tool held by a user with at least one of his hands;

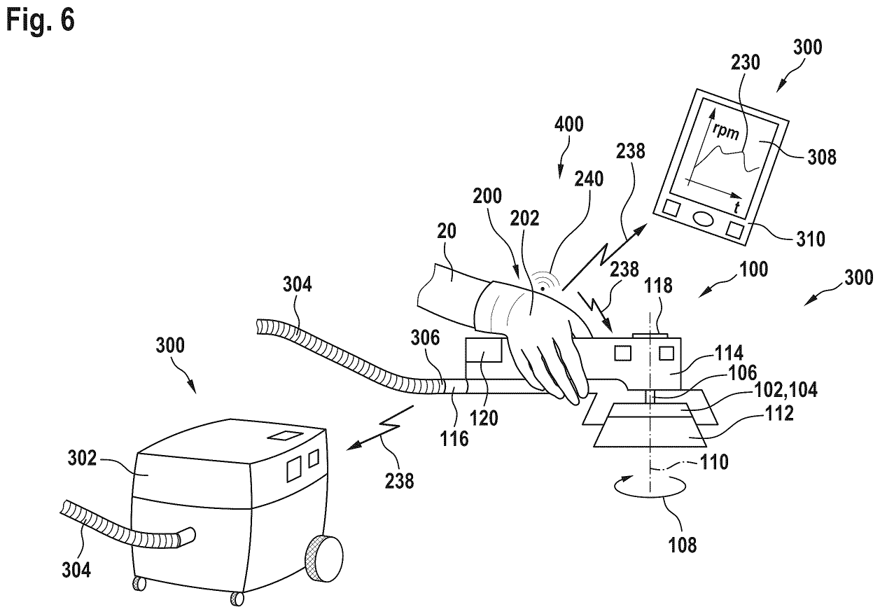

FIG. 6 a power tool system according to a preferred embodiment of the invention;

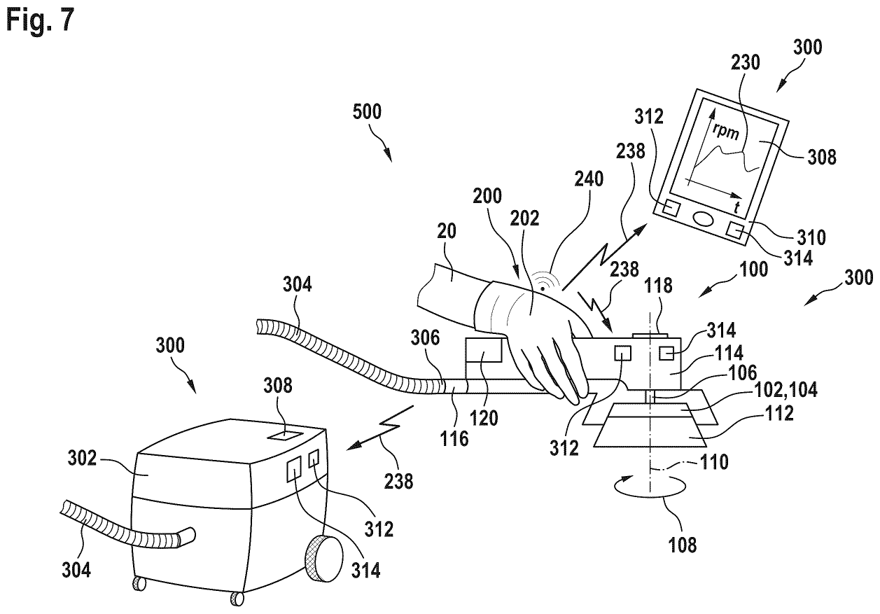

FIG. 7 an electronic appliance system according to a preferred embodiment of the invention; and

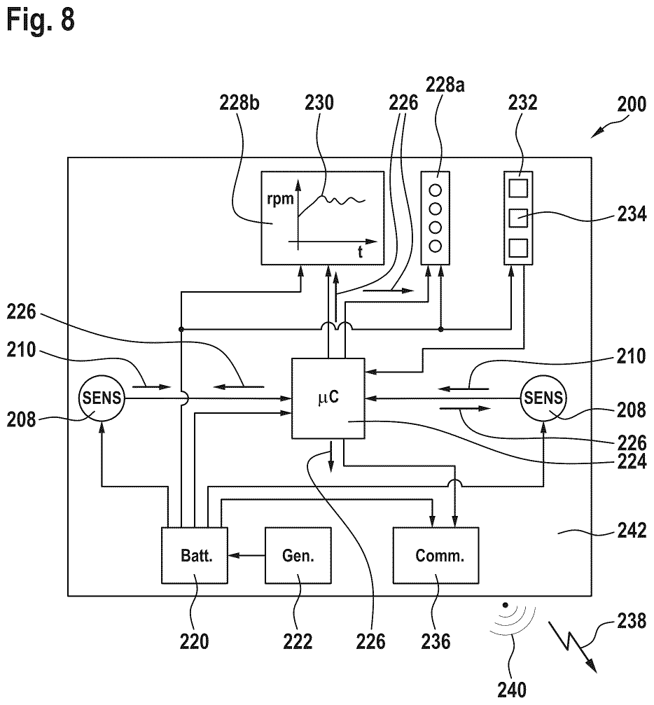

FIG. 8 a schematic view of the electric and electronic components provided in a wearable device according to a preferred embodiment of the invention.

FIG. 1 shows the hand 10 of a user of a power tool 100. The hand 10 comprises fingers 12 and a thumb 14 as well as a palm 16 on an inner surface and a back 18 of the hand 10 opposite to the palm 16 on an outer surface of the hand 10. The hand 10 connects to the user's body by an arm 20. A wrist 22 is formed between the hand 10 and the arm 20.

The power tool 100 may comprise any kind of motor driven power tool having a working element 102 driven by the motor 120 for working a surface during intended use of the power tool 100, e.g., in the form of a grinder, a sander, a polisher, a drill, a saw or the like. The tool motor 120 may be an electric or a pneumatic motor. The working element 102 may be a backing plate 104, a grinding wheel, a drill chuck with a drill bit removably received and held firmly therein, a circular saw or a jig saw.

The invention suggests a wearable device 200 comprising a glove 202 (see FIG. 2), a bracelet 204 (see FIG. 3), a ring 206 (see FIG. 4) or the like. In particular, the invention suggests an intelligent wearable device 200 which comprises at least one sensor element 208 configured to detect an operational status of a power tool 100 held by the user during intended use of the power tool 100 and further configured to generate and output at least one sensor signal 210 indicative of the detected operational status of the power tool 100.

Preferably, the power tool 100 comprises a polisher or a sander having a working element 102 in the form of a backing plate 104 driven by the motor 120 of the power tool 100. The backing plate 104 is attached to a driving shaft 106 of the power tool 100 and performs a certain type of working movement 108 (e.g., rotational, random-orbital, eccentric, gear driven) about a rotational axis 110 of the driving shaft 106. Direct attachment of the backing plate 104 to the driving shaft 106 makes the backing plate 104 perform a rotational movement 108 during intended use of the power tool 100. An eccentric element (not shown) may be located between the backing plate 104 and the driving shaft 106. The eccentric element may be fixedly attached to the driving shaft 106 in a torque proof manner while the backing plate 104 is held freely rotatable in a surface of the eccentric element opposite to the driving shaft 106. This makes the backing plate 104 perform a random-orbital movement during intended use of the power tool 100. If free rotation of the backing plate 104 in respect to the tool housing 114 is prevented, the backing plate will perform an eccentric movement. Furthermore, gear arrangement, in particular a planetary gear, may be located between the backing plate 104 and the driving shaft 104. This will make the backing plate 104 perform a gear-driven working movement during intended use of the power tool 100.

A polishing or sanding member 112 may be attached to a bottom surface of the backing plate 104. A polishing member may comprise a polishing pad made of foam, wool, microfiber or the like. A sanding member may comprise a sanding paper or a sanding fabric. The polishing or sanding member 112 is preferably releasably attached to the backing plate 104 by means of a hook-and-loop fastening system (Velcro®). Although other possibilities for releasable attachment of the polishing or sanding member 112 to the backing plate 104 are conceivable, too.

The user may hold the power tool 100 with at least one of his hands 10, possibly with both hands 10 (see FIG. 5), thereby grasping the power tool housing 114 and/or a grip or handle 116 of the power tool 100. When wearing the wearable device 200 on at least one hand 10 with which he grasps the power tool housing 114 and/or the grip or handle 116 of the power tool 100, the one or more sensor devices 208 provided inside the wearable device 200 may detect an operational status of the power tool 100.

The at least one sensor element 208 is held by a support structure making part of the wearable device 200. The support structure is designed such that, in the case of a ring 206, it may be worn and firmly held on a user's finger 12, in the case of a bracelet 204, it may be worn around a user's wrist 22 and securely held on the user's wrist 22, and, in the case of a glove 202, it may be worn on a user's hand 10 and cover the entire hand 10 or only part of it. The support structure may be rigid or flexible, preferably elastic. The support structure may comprise any material including metal, wood, plastic, a mesh of natural or synthetic fibres, some kind of fabric (weave) made of synthetic or natural materials, synthetic or natural leather, or the like.

In the case of a wearable device 200 in the form of an intelligent glove 202 (see FIG. 2), the support structure is preferably a layer of textile or fabric 212 to which the at least one sensor element 208 is attached. Preferably, the at least one sensor element 208 is integrated into the textile or fabric layer 212. Further layers of textile or fabric may be provided on top of the support structure 212 and the at least one sensor element 208 attached thereto such that the at least one sensor element 208 is integrated into the wearable device 200. Of course, in an intelligent glove 202, the support structure could also comprise one or more flexible or rigid PCBs 242 or other components suitable for providing a support functionality within the intelligent glove 202.

In the case of a wearable device 200 in the form of a bracelet 204 (see FIG. 3), the support structure is preferably part of or attached to a housing 214 of the bracelet 204. In that case, the support structure 214 is preferably made of a rigid material such as metal, a rigid plastic material or the like. Straps 216 or the like may be attached to the bracelet housing 214 for attachment of the bracelet 204 to the wrist 22 of the user. The straps 216 may be made of the same or a different material than the housing 214. Preferably, the straps 216 are made of a soft plastic material, chain links made of a rigid plastic material or metal, a fabric or the like. Alternatively, the support structure could also comprise one or more flexible or rigid PCBs 242 or other components located inside the bracelet housing 214.

In the case of a wearable device 200 in the form of a ring 206 (see FIG. 4), the support structure is preferably part of or attached to a housing 218 of the ring 206. In that case, the support structure 218 is preferably made of a rigid material such as metal, a rigid plastic material or the like. A shackle or an eyelet (not visible in FIG. 4) may be attached to the ring housing 218 for attachment of the ring 206 to a finger 12 or the thumb 14 of the user. The shackle or an eyelet may be made of the same or a different material than the housing 218. Preferably, the shackle or an eyelet are made of the same material and form one part with the housing 218. Alternatively, the support structure could also comprise one or more flexible or rigid PCBs 242 or other components located inside the ring housing 218.

The operational status of the power tool 100 which may be detected by the at least one sensor device 208 of the wearable device 200 may comprise an on/off-status of the power tool 100, a rotational speed of a working element 102, an operation temperature of the power tool 100, current vibration values of the power tool 100, irregularities of vibrations over time, current frequency values of vibrations, frequency values of vibrations over time, accumulated vibrations over a certain period of time, electric energy or power consumption of a tool motor 120, overall usage time of the power tool 100, etc.

Preferably, the at least one sensor device 208 is configured to detect an operational status of the tool motor 120 of the power tool 100. The motor 120 may be a pneumatic motor or an electric motor, in particular a brushless electric motor. The operational status of the motor 120 may comprise an on/off-status of the motor 120, a rotational speed of a motor shaft, an operation temperature of the motor 120, current vibration values of the motor shaft, irregularities of vibrations, frequencies of vibrations, accumulated vibrations over a certain period of time, electric energy or power consumption of the tool motor 120, overall operation time of the tool motor 120, etc.

The at least one sensor device 208 may also be configured to detect an operational status of the working element 102 of the power tool 100, in particular of the backing plate 104 of a polishing or sanding power tool 100. The operational status of the working element 102 may comprise an on/off-status, i.e., rotating yes or no, of the backing plate 104, a rotational speed of the working element 102, current vibration values of the backing plate 104 (with a polishing or sanding member 112 attached thereto), irregularities of vibrations, frequencies of vibrations, accumulated vibrations over a certain period of time, etc. A decentralised or eccentric attachment of the polishing or sanding member 112 to a bottom surface of the backing plate 104 may result in larger vibrations of the backing plate 104 and of the entire power tool 100.

The at least one sensor device 208 may be configured to detect vibrations caused by the power tool 100 during its intended use. In this case, the at least one sensor device 208 preferably comprises an acceleration sensor. Vibrations of the motor 120 or of the working element 102 during intended use of the power tool 100 are transmitted to the tool housing 114 and further to the hand 10 of the user holding the power tool 100 and further to the wearable device 200 removably attached to the user's hand 10. The at least one sensor device 208 may then detect these vibrations of the wearable device 200 and can then draw conclusions about the vibrations of the power tool 100, the motor 120 or the working element 102.

By monitoring and evaluating characteristic courses of the vibrations over time, conclusions can be drawn about the speed of the power tool 100, the motor 120 or the backing plate 104. In particular, it can be determined whether and when the power tool 100 is turned on and turned off again. Depending on this information regarding the operational status of the power tool 100, an external electronic appliance 300 could be controlled accordingly. For example, a vacuum cleaner 302 having a suction hose 304 a distal end 306 of which being attached to a dust outlet 116 of the power tool 100 held by the user could be controlled automatically depending on the operational status of the power tool 100 detected by the at least one sensor element 208. In particular, when an activation of the power tool 100 is detected, the vacuum cleaner 302 could also be turned on, and when a deactivation of the power tool 100 is detected, the vacuum cleaner 302 could also be turned off, possibly with a slight time delay.

Alternatively or additionally, the at least one sensor device 208 may be configured to detect a speed of the power tool 100, the motor 120 or the backing plate 104. In this case, the at least one sensor device 208 preferably comprises a radio receiver adapted for receiving a radio signal (not shown) from the power tool 100 transmitting information relating to the speed of the power tool 100, the motor 120, or the backing plate 104. The speed value can be measured by means of a sensor making part of the power tool 100, e.g., a magnetic field sensor, e.g., a Hall effect sensor, and transmitted to a motor control unit (ECU) of the power tool 100. Anyhow, even in power tools 100 with sensorless motor control, the ECU usually has an exact or estimated value of the current speed of the motor 120 available. The speed value can be transmitted to the radio receiver 208 of the wearable device 200 by means of one or more radio signals (not shown). Alternatively, the sensor device 208 may comprise a magnetic field sensor (not shown), e.g., a Hall effect sensor, and the working element 102, e.g., the backing plate 104, may be provided with one or more permanent magnets (not shown) which create a magnetic field which rotates together with the working element 102 during intended use of the power tool 100. The changes of the magnetic field during rotation of the working element 102 can be detected by the static sensor device 208 and from that the speed of the working element 102 can be determined.

Additionally, the wearable device 200 may comprise an electric energy storage device 220 and/or an electric energy generation device 222 (see FIG. 8), preferably held by the support structure 212; 214; 218 and configured to provide electric energy to the at least one sensor device 208 for its operation and possibly to further electric or electronic components making part of the wearable device 200 for their operation. The electric energy storage device 220 comprises batteries (exchangeable or rechargeable), capacitors or the like. An electric energy generation device 222 may generate electric energy during intended use of the power tool 100, which is held by the user with his hand 10. For instance, the energy generating device 222 can create electric energy from vibrations occurring during intended use of the power tool 100. The energy generation device 222 may be connected to the at least one sensor device 208 and possibly to other electric or electronic components of the wearable device 200 either directly or indirectly through the electric energy storage device 220, which could serve as an intermediate storage or buffer for the electric energy generated by the energy generating device 222. Preferably, the energy generating device 222 is manufactured in semiconductor technology and comprises, for instance, a piezoelectric element configured to transform mechanical movement into electric energy.

It is further suggested that the wearable device 200 comprises a further electric or electronic component in the form of a processing module 224, preferably held by the support structure 212; 214; 218 and adapted for receiving the at least one sensor signal 210 from the at least one sensor device 208 and for processing the received at least one sensor signal 210. The processing module 224 may comprise a microprocessor or a microcontroller adapted to execute a computer program stored on a storage device making part of the processing module 224 or being separate from the processing module 224 (e.g., located remote from the processing module 224 in the wearable device 200) but accessible by the processing module 224. The computer program is programmed to make the processing module 224 perform its processing functionality when executed on the processing module 224. The processing functionality may comprise one or more of the following:
receiving the at least one sensor signal 210 indicative of the detected operational status of the power tool 100 from the at least one sensor device 208 of the wearable device 200,
extracting the operational status of the power tool 100 from the at least one received sensor signal 210,
generating at least one control signal 226 depending on the extracted operational status of the power tool 100,
forwarding the at least one control signal 226 to at least one further electric or electronic component of the wearable device 200 (e.g., to the processing module 224, a visual output device 228, a wireless communication device 236, a user control interface 232),
controlling operation of the at least one sensor device 208 and possibly of at least one further electric or electronic component of the wearable device 200 (e.g., of the processing module 224, of a visual output device 228, of a wireless communication device 236, of a user control interface 232).

If the operational status of the power tool 100 is a speed of the tool motor 120 or of the working element 102, “receiving the at least one sensor signal 210” may comprise receiving a radio signal (not shown) from the power tool 100, the radio signal containing an information indicative of a value of the current speed of the motor 120 or of the working element 102 previously measured by means of a sensor element of the power tool 100 adapted for measuring the speed in any possible manner (e.g., magnetically, optically, capacitively, etc.). The measured speed may be transmitted to a motor control unit (ECU; not shown) of the power tool 100, where it may be packed into a radio signal and transmitted to the sensor element 208. In that case, the sensor element 208 preferably comprises a radio receiver. Alternatively, in power tools 100 with a sensorless control of the motor 120, the ECU usually has information representative of the current speed of the motor 120 or from which the speed of the motor 120 can be deducted.

The wearable device 200 may comprise a further electric or electronic component in the form of a visual output device 228, preferably held by the support structure 212; 214; 218 and adapted for visualizing to the user holding the power tool 100 an indication of the operational status of the power tool 100 or the operational status of the power tool 100 itself. The information visualized by the visual output device 228 may be controlled by the processing module 224 through respective control signals 226.

The visual output device 228 may comprise one or more light points 228a capable of emitting light with different brightness, flashing intervals and/or colours. For instance, the light points 228a may comprise one or more LEDs capable of emitting light of different colours or an RGB-LED. Light emitted from one or more of the light points 228a with a certain brightness, flashing interval and/or colour is representative of a certain operational status of the power tool 100. For instance, light from a green LED may indicate regular operation and intended use of the power tool 100, light from a yellow LED may indicate an idle state of the power tool 100 (working element 102 rotating but power tool 100 not in its intended use), and light from a red LED may indicate that the power tool 100 is turned off (working element 102 not rotating). Alternatively, light from a green LED may indicate an overall operational time of the power tool 100 well below a threshold time value (requesting maintenance of the power tool 100 when reached or exceeded), light from a yellow LED may indicate an overall operational time of the power tool 100 just below the threshold time value (e.g., within 20% below the threshold value), and light from a red LED may indicate that the overall operational time of the power tool 100 has reached or exceed the threshold time value.

Furthermore, the visual output device 228 may comprise a light guide or an electroluminescent (EL) wire (both not shown in the figures) having a longitudinal extension. Light with different brightness, flashing intervals and/or colours may be coupled into the light guide, preferably at a distal end thereof, propagated along the longitudinal extension of the light guide, preferably by means of total internal reflection (TIR) and finally coupled out of the light guide along the longitudinal extension of the light guide in a radial direction. To this end, the light guide may be provided with respective decoupling elements along the longitudinal extension of the light guide.

An EL wire is a flexible lighting product that emits light along its longitudinal extension in a radial direction when an alternating current (AC) voltage is applied to it. It comprises a thin copper or tin-plated wire coated with a phosphor material and encased in a transparent or translucent PVC sheath. Different types of phosphors can be used to produce different colours of light, such as green, blue, red, or white. Additionally, an EL wire can be made to have various lighting effects, including steady glow, blinking, or chasing patterns by controlling the AC power source. To power the EL wire, an inverter is required to convert a DC power source (such as a battery 220) into the AC voltage needed for the EL wire to function. The inverter generates the appropriate frequency and voltage to drive the EL wire and typically includes controls for adjusting brightness and lighting modes. The inverter functionality can be performed by the processing module 224 or by a separate component, which is possibly controlled by the processing module 224.

Finally, the visual output device 228 may also comprise a graphic display or screen 228b, such as a LED-display, an OLED-display, or the like. It is preferred that the graphic display or screen 228b is flexible in order to follow movement and bend of the glove 202 covering the back 18 of the hand 10 (see FIG. 2). Such displays or screens 228b may output the detected operational status of the power tool 100 graphically, for instance in the form of a graph 230 over time, a bar graph, a column graph, as a virtual analogue display with pointer instrument, as virtual digital display with numbers or the like. The graphic display or screen 228b may be a touch-sensitive display or screen providing a user control interface adapted to be actuated by the user holding the power tool 100 in order to achieve a user-individual control of the wearable device 200 and/or of one or more remote external electronic appliances 300, such as a vacuum cleaner 302, as will be described in more detail below.

Preferably, the display or screen 228b is flexible in order to be able to adapt to the user's hand movements together with the intelligent glove 202. Further preferably, the visual output device 228 is located in or on the wearable device 200 such that the user wearing the wearable device 200 on or near his hand 10 can grasp the information displayed while holding the power tool 100 with his hand 10 and using the power tool 100 as intended. For instance, in the case of a wearable device 200 in the form of a glove 202, it is suggested that the visual output device 228 is located on the back 18 of the hand 10 or glove 202 (see FIG. 2).

The wearable device 200 may comprise a further electric or electronic component in the form of at least one user control interface 232, preferably held by the support structure 212; 214; 218 and adapted to be actuated by the user holding the power tool 100 in order to achieve a user-individual control of the wearable device 200 and/or of one or more remote external electronic appliances 300, such as a vacuum cleaner 302, as will be described in more detail below. The functionality of the user control interface 232 could also be provided by a touch-sensitive graphic display or screen 228b. The user control interface 232 comprises one or more physical or virtual buttons 234, knobs, rotary or slider controls, input fields for entering data or quantities, etc. Preferably, the user control interface 232 is configured such that it can be actuated by the user even when wearing gloves. Preferably, the user control interface 232 is provided on a back 18 of the user's hand 20 or of the intelligent glove 202.

The wearable device 200 may comprise a further electric or electronic component in the form of a wireless communication device 236, preferably held by the support structure 212; 214; 218 and adapted for establishing a wireless communication link 238 to an external electronic appliance 300 and for transmitting across the wireless communication link 238 a wireless signal 240 containing information indicative of the detected operational status of the power tool 100 and possibly other information (see FIGS. 6 and 7). The wireless communication device 236 may be controlled by the processing module 224 of the wearable device 200. To this end, it is suggested that the wireless communication device 236 is connected to the processing module 224 and adapted to receive control signals 226 from the processing module 224 in order to make the wireless communication device 236 establish the wireless communication link 238 to the external electronic appliance 300 and transmit the wireless signal 240. The other information transmitted across the wireless communication link 238 may comprise information indicative of an actuation of a user control interface 232 of the wearable device 200 by a user of the power tool 100.

The wireless communication device 236 is in particular configured to establish a radio communication link 238 to the external electronic appliance 300 using any desired frequency range. The wireless communication device 236 may further be configured to transmit the wireless signal 240 across the wireless communication link 238 according to any given data transmission protocol, be it known in the art or be it a proprietary protocol. Examples for protocols which may be used for data transmission from the wireless communication device 236 to the external electronic appliance 300 are: WiFi, any cellular network protocol (GSM, UMTS, LTE, 5G), Bluetooth, ZigBee, Z-Wave (operating in sub-GHz frequency range), Thread (IP-based wireless networking protocol using low-power IEEE 802.15.4 radio standard and operating on 2.4 GHz frequency), WirelessHART (based on HART (Highway Addressable Remote Transducer) protocol and operating in the 2.4 GHz frequency range), ANT/ANT+ (operating on 2.4 GHz frequency and typically offering low-power, short-range communication between sensors and display devices), EnOcean (focussing on energy harvesting and ultra-low-power devices, enabling self-powered devices to transmit data wirelessly using energy from their surroundings, such as solar, thermal, or mechanical energy), just to name a few.

Examples for electronic appliances 300, to which the wireless communication device 236 may establish the wireless communication link 238, are:
An external display device 308, possibly making part of a smartphone 310, the vacuum cleaner 302 or the like (see FIG. 7). One or more detected operational states of the power tool 100 or any other information received from the wireless communication device 236 of the wearable device 200 can be displayed on the external display device 308 graphically, for instance in the form of a graph 230 over time or in any other manner. Thus, the wireless communication device 236 transmits wireless signals 240 to the external display device 308 containing information about the detected operational status of the power tool 100. The smartphone 310 could also be used by a user to control functionality of the wearable device 200 and any other external electronic appliance 300 connected thereto through a wireless communication link 238. To this end, control signals (not shown) could be transmitted from the smartphone 310 to the wireless communication device 236 across the wireless communication link 238.
A vacuum cleaner 302 having a suction hose 304 the distal end 306 of which being attached to the dust outlet 116 of the power tool 100 held by the user (see FIG. 7). The vacuum cleaner 302 may be controlled automatically depending on the information contained in the wireless signals 240 received from the wireless communication device 236 and indicative of the operational state of the power tool 100. When the power tool 100 is turned on, the vacuum cleaner 302 may also automatically be turned on, and when the power tool 100 is turned off, the vacuum cleaner 302 may also automatically be turned off, possibly with a slight time delay.
The power tool 100 held by the user (see FIG. 7). The power tool housing 114 may be equipped with a visual output device 118, which may display to the user graphically or by means of light points information received from the wireless communication device 236, in particular relating to the current operational status of the power tool 100. Additionally or alternatively, operation of the power tool 100 could be adapted or controlled based on the information contained in the wireless signal 240 received from the wireless communication device 236.

The visual output device 118 of the power tool 100 and/or the external display device 308 of the smartphone 308 or the vacuum cleaner 302 may be embodied similar to what has been described above in respect to the visual output device 228 of the wearable device 200. In particular, the visual output device 118 and/or the external display device 308 may comprise light points, similar to light points 228a, an EL-wire, a light guide and/or a graphic display or screen, similar to graphic display or screen 228b.

In order to establish the wireless communication link 238 between the wireless communication device 236 and the external electronic appliance 300, the respective appliance 300 is provided with a respective wireless communication device 312. Furthermore, in order to control data communication and internal processing of the received wireless signals 240, the respective appliance 300 may be provided with a processing module 314, in particular comprising a microcontroller or a microprocessor. The data transmission between the wireless communication devices 236, 312 of the wearable device 200 and the electronic appliance 300 is preferably bi-directional, at least during establishing and setting up the wireless communication link 238. The actual data transmission between the wireless communication devices 236; 312 may be uni-or bi-directional. The wireless communication device 312 may be used for transmitting a detected speed of the tool motor 120 to the sensor device 208 of the wearable device 200.

Signal transmission between various electric or electronic components 208, 220, 222, 224, 228, 232 of the wearable device 200 may be effected by means of electrically conductive cables, conductive paths of flexible or rigid PCBs 242 or the like. Cables may be integrated into a fabric 212 of a glove 202. In the embodiment of FIG. 8, all electronic components 208, 220, 222, 224, 228, 232 are attached and electrically connected to a flexible PCB 242 which may be integrated into the fabric 212 of a glove 202 as a single unit, which considerably simplifies and accelerates the manufacture of the intelligent glove 202 according to the invention. Alternatively, signal transmission between the components 208, 220, 222, 224, 228, 232 of the wearable device 200 could also be realized through radio transmission. The power transmission from the electric energy storage device 220 and/or the energy generation device 222 to the one or more electric or electronic components 208, 224, 228, 232 of the wearable device 200 is preferably realized through conductive cables, conductive paths of flexible or rigid PCBs 242 or inductively.

FIG. 6 shows a power tool system 400 according to the present invention, comprising the hand-held power tool 100 configured to be held by a user during intended use of the power tool 100 and further comprising a wearable device 200, preferably in the form of a glove 202 or a bracelet 204 or a ring 206. The wearable device 200 is adapted to be worn by the user on or close to his hand 10 while holding the power tool 100 with that hand.

FIG. 7 shows an electronic appliance system 500 comprising an external electronic appliance 300 and a wearable device 200 according to the present invention, preferably in the form of a glove 202 or a bracelet 204 or a ring 206. The wearable device 200 is adapted to be worn by a user of a hand-held power tool 100 on or close to his hand 10 holding the power tool 100. The electronic appliance 300 may be a smartphone 310, the power tool 100 or a vacuum cleaner 302.

1. Wearable device (200), including a glove (202) or a bracelet (204) or a ring (206), adapted to be worn by a user of a hand-held power tool (100) on or close to a user's hand (10) while holding the hand-held power tool (100) with the user's hand (10),
wherein
the wearable device (200) comprises a support structure (212; 214; 218) adapted to be releasably attached to the user's hand (10) and at least one sensor device (208) held by the support structure (212; 214; 218) and configured to detect an operational status of the hand-held power tool (100) held by the user with the user's hand (10) when using the hand-held power tool (100) and further configured to generate and output at least one sensor signal (210) indicative of the operational status detected of the hand-held power tool (100).

2. Wearable device (200) according to claim 1, wherein the at least one sensor device (208) is configured to detect the operational status of a motor (120) of the hand-held power tool (100).

3. Wearable device (200) according to claim 1, wherein the at least one sensor device (208) is configured to detect vibrations caused by the hand-held power tool (100) when being used.

4. Wearable device (200) according to claim 1, wherein the at least one sensor device (208) comprises an acceleration sensor or a hall sensor.

5. Wearable device (200) according to claim 1, wherein the wearable device (200) comprises an electric energy storage device (220) and/or an electric energy generation device (222), including where the electric energy storage device (220) and/or the electric energy generation device (222) is held by the support structure (212; 214; 218) and configured to provide electric energy to the at least one sensor device (208) for its operation, or to further electric or electronic components (224; 228; 232; 236) making part of the wearable device (200) for their operation, or to both the at least one sensor device (208) and the further electric or electronic components (224:228: 232; 236).

6. Wearable device (200) according to claim 1, wherein the wearable device (200) comprises a further electric or electronic component in the form of a processing module (224), including where the processing module (224) is held by the support structure (212; 214; 218) and adapted for receiving the at least one sensor signal (210) from the at least one sensor device (208) and for processing the at least one sensor signal (210) received.

7. Wearable device (200) according to claim 1, wherein the wearable device (200) comprises a further electric or electronic component in the form of a visual output device (228), including where the visual output device (228) is held by the support structure (212; 214; 218) and adapted for visualizing to the user holding the power tool (100) an indication of the operational status of the hand-held power tool (100) or the operational status of the hand-held power tool (100) itself.

8. Wearable device (200) according to claim 7, wherein the Wearable device (200) comprises a further electric or electronic component in the form of a processing module (224); and the visual output device (228) is connected to the processing module (224) and adapted to receive control signals (226) from the processing module (224) in order to make the visual output device (228) visualize to the user holding the hand-held power tool (100) the indication of the operational status of the hand-held power tool (100) or the operational status of the hand-held power tool (100) itself.

9. Wearable device (200) according to claim 1, wherein the wearable device (200) comprises a further electric or electronic component in the form of at least one user control interface (232), including where the at least one user control interface (232) is held by the support structure (212; 214; 218) and adapted to be actuated by the user holding the hand-held power tool (100) in order to achieve a user-individual control of the wearable device (200), or in order to achieve a user-individual control of an external electronic appliance (300) connected to the wearable device (200) by means of a wireless communication link (238).

10. Wearable device (200) according to claim 1, wherein the wearable device (200) comprises a further electric or electronic component in the form of a wireless communication device (236), including where the wireless communication device (236) is held by the support structure (212; 214; 218) and adapted for establishing a wireless communication link (238) to an external electronic appliance (300) and for transmitting across the wireless communication link (238) a wireless signal (240) containing information indicative of the operational status detected of the hand-held power tool (100), as well as other information.

11. Wearable device (200) according to claim 10, wherein the wearable device (200) comprises a further electric or electronic component in the form of a processing module (224); and the wireless communication device (236) is connected to the processing module (224) and adapted to receive control signals (226) from the processing module (224) in order to make the wireless communication device (236) establish the wireless communication link (238) to the external electronic appliance (300) and transmit across the wireless communication link (238) the wireless signal (240) containing the information indicative of the detected operational status of the hand-held power tool (100).

12. Power tool system (400) comprising the wearable device (200) according to claim 1.

13. Power tool system (400) according to claim 12, wherein the hand-held power tool (100) comprises a polishing or sanding power tool, including an angular polishing or sanding power tool.

14. Electronic appliance system (500) comprising an electronic appliance (300) and the wearable device (200) according to claim 10.

15. Electronic appliance system (500) according to claim 14, wherein the electronic appliance (300) comprises a vacuum cleaner (302), or a smartphone (310), a tablet computer, a laptop computer or any other kind of computer system.

16. Wearable device (200) according to claim 2, wherein the at least one sensor device (208) is configured to detect vibrations caused by the hand-held power tool (100) when being used.

17. Wearable device (200) according to claim 3, wherein the at least one sensor device (208) comprises an acceleration sensor or a hall sensor.

18. Wearable device (200) according to claim 2, wherein the wearable device (200) comprises an electric energy storage device (220) and/or an electric energy generation device (222), including where the electric energy storage device (220) and/or the electric energy generation device (222) is held by the support structure (212; 214; 218) and configured to provide electric energy to the at least one sensor device (208) for its operation, or to further electric or electronic components (224; 228; 232; 236) making part of the wearable device (200) for their operation, or both the at least one sensor device (208) and the further electric or electronic components (224; 228; 232; 236).

19. Wearable device (200) according to claim 2, wherein the wearable device (200) comprises a further electric or electronic component in the form of a processing module (224), including where the processing module (224) is held by the support structure (212; 214; 218) and adapted for receiving the at least one sensor signal (210) from the at least one sensor device (208) and for processing the at least one sensor signal (210) received.

20. Wearable device (200) according to claim 2, wherein the wearable device (200) comprises a further electric or electronic component in the form of a visual output device (228), including where the visual output device (228) is held by the support structure (212; 214; 218) and adapted for visualizing to the user holding the power tool (100) an indication of the operational status of the hand-held power tool (100) or the operational status of the hand-held power tool (100) itself.

21. Electronic appliance system (500) comprising an electronic appliance (300) and the wearable device (200) according to claim 11.

22. Electronic appliance system (500) according to claim 21, wherein the electronic appliance (300) comprises a vacuum cleaner (302) or a smartphone (310), a tablet computer, a laptop computer or any other kind of computer system.
